(19) United States
(12) Patent Application Publication
(10) Pub. No.: US 2005/0033833 A1
(43) Pub. Date: Feb. 10, 2005

(54) Method, system, and program product fo rmanaging device identifiers

(75) Inventors: Frank P. Baldiga, Apex, NC (US); Micah M. Cross, Creedmoor, NC (US); Kent F. Hayes JR., Chapel Hill, NC (US)

Correspondence Address: Gerald R. Woods;IBM Corporation T81/503, PO Box 12195, Research Triangle Park, NC, 27709, US

(73) Assignee: International Business Machines Corporation, Armonk, NY (US)

(21) Appl. No.: 10/634,260

(22) Filed: Aug. 5, 2003

(51) Int. Cl. G06F 15/177

(52) U.S. Cl. 709/222

(57) ABSTRACT

Method, system, and program product for managing device identifiers. A set of device entries is managed at a server. Each device entry includes a device identifier and associated correlation data. A device can request a device identifier from the server using correlation data for the device. A unique device identifier can be generated when the request is received and/or when the device entry is created. In any event, the device identifier can be communicated to the device that made the request.

### CROSS-REFERENCE TO CO-PENDING APPLICATION

This application is related in some aspects to a commonly owned U.S. patent application entitled “Method, System, and Program Product for Robustly Assigning Device Identifiers,” and identified by IBM Docket No. RSW920030052US1, which is hereby incorporated by reference.

### BACKGROUND OF THE INVENTION

1. Technical Field

The invention relates generally to managing device identifiers for devices in a network, and more specifically, to managing device identifiers at a server, and assigning device identifiers to devices in the network.

2. Related Art

Increasingly, users are seeking to connect to networks with various computing devices (e.g., a laptop, a desktop, a handheld device, etc.). In order to communicate within a network, a device identifier is generally assigned to each device. The device identifier is typically unique among all devices in the network. When a message is sent to a device, the device identifier is included in the message to identify the particular device. This allows each device in the network to readily determine whether it is the intended recipient. When the device identifier in the message matches the device identifier for the device, the device will process the message. The use of device identifiers also enables the devices to be centrally managed. For example, management action can be assigned to a particular device at the server. The next time the assigned device connects to the server, the assigned operation is run on the device.

For some types of devices, a device identifier is not readily obtainable. For example, a device may not include a serial number that could be used, or the uniqueness of serial numbers may not be assured. Additionally, a uniform format for the device identifier may be desired to improve the efficiency of communications. As a result, networks that include several types of devices (e.g., a pager, a mobile phone, a personal assistant, a computer, etc.) may not wish to use the device serial number or the like.

Several solutions have been provided for assigning device identifiers to devices. In many solutions, a user of the device is required to manually enter the device identifier. However, as networks have become larger and more complex, device identifiers have gotten longer and increasingly arbitrary. As a result, entry of the device identifier is often difficult for the user, increasing the likelihood of errors. This problem is compounded for a user having several devices. Other solutions provide that each device automatically generate its own identifier. However, these solutions are often complex to implement because they attempt to ensure that the generated device identifier will be unique. Even still, uniqueness of the device identifiers is often not ensured until the device identifier is confirmed by a server on the network. Still further, since the server does not know of the device until it initiates communication, no management of the device can take place on the server prior to the device connecting to the network.

As a result, a need exists for an improved method, system, and program product for managing device identifiers. In particular, a need exists to manage device identifiers at a server on the network. Further, a need exists for assigning the device identifiers to devices that connect to the network. Still yet, a need exists for a device identifier management system that associates particular users with particular devices.

### SUMMARY OF THE INVENTION

The invention provides a method, system, and program product for managing device identifiers. Specifically, under the present invention, a server manages a set of device entries. Each device entry includes a device identifier, and correlation data. The correlation data can include a device type and user data so that a particular user is associated with a particular device. Initially, the device will initially request a device identifier from the server. The request will typically include correlation data for the user and the device. Using the correlation data in the request, the server can identify a corresponding device entry for the user and the particular device. The server can then communicate the device identifier in the corresponding device entry back to the device. Under the present invention, device entries can be generated before, or after the device requests the device identifier. For example, an administrator may enter user data for a particular user and device prior to receiving any requests. Subsequently, when the user initially connects to the server using the device, the corresponding device entry is identified and the device identifier therein is retrieved. Thus, the present invention provides an improved solution for centrally managing and/or assigning device identifiers.

A first aspect of the invention provides a method of managing device identifiers, the method comprising: providing a set of device entries at a server; generating a unique device identifier for each of the set of device entries; and associating correlation data with each of the set of device entries, wherein the correlation data includes a device type and user data.

A second aspect of the invention provides a method of assigning a device identifier, the method comprising: providing a set of device entries at a server, wherein each device entry includes a device identifier and correlation data; receiving a request from a device, wherein the request includes correlation data for the device; identifying one of the set of device entries by comparing the correlation data in the request to the correlation data in the set of device entries; and communicating the device identifier from the one of the set of device entries to the device.

A third aspect of the invention provides a system for managing device identifiers, the system comprising: a management system for managing a set of device entries at a server, wherein the management system includes: a generation system for generating a unique device identifier for each of the set of device entries; and an entry update system for associating correlation data with each of the set of device entries, wherein the correlation data includes a device type and user data.

A fourth aspect of the invention provides a program product stored on a recordable medium for managing device identifiers, which when executed comprises: program code for automatically generating a unique device identifier for each of a set of device entries; and program code for associating correlation data with each of the set of device entries, wherein the correlation data includes a device type and user data.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative system according to one aspect of the invention;

FIG. 2 shows an illustrative set of device entries according to yet another aspect of the invention;

FIG. 3 shows an illustrative system according to another aspect of the invention; and

FIG. 4 shows illustrative steps performed by both the server and the device when assigning a device identifier.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above the invention provides a method, system, and program product for managing device identifiers. Specifically, under the present invention, a server manages a set of device entries. Each device entry includes a device identifier, and correlation data. The correlation data can include a device type and user data so that a particular user is associated with a particular device. Initially, the device will initially request a device identifier from the server. The request will typically include correlation data for the user and the device. Using the correlation data in the request, the server can identify a corresponding device entry for the user and the particular device. The server can then communicate the device identifier in the corresponding device entry back to the device. Under the present invention, device entries can be generated before, or after the device requests the device identifier. For example, an administrator may enter user data for a particular user and device prior to receiving any requests. Subsequently, when the user initially connects to the server using the device, the corresponding device entry is identified and the device identifier therein is retrieved. Thus, the present invention provides an improved solution for centrally managing and/or assigning device identifiers.

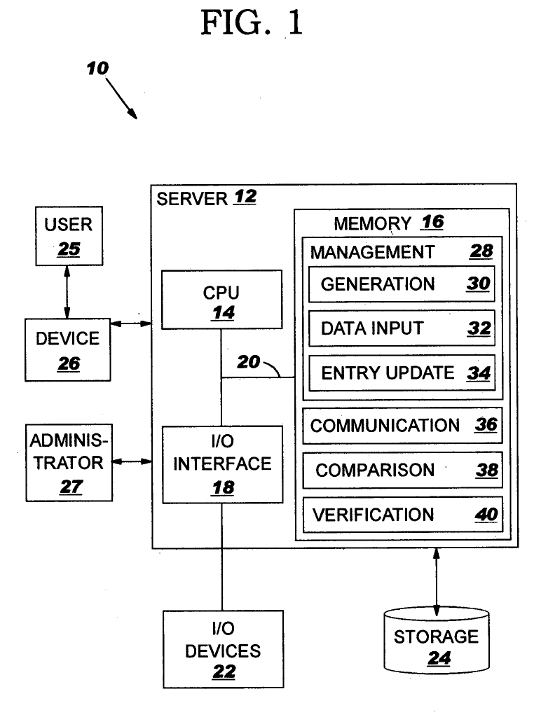

Turning to the drawings, FIG. 1 shows an illustrative system 10 according to one embodiment of the invention. System 10 allows a unique device identifier to be generated based on a particular user and device. As shown, system 10 includes a server 12 and a device 26. Device 26 communicates with server 12 over a network. The network can comprise any type of network, including the Internet, a wide area network (WAN), a local area network (LAN), a virtual private network (VPN), etc. To this extent, communication can occur via a direct hardwired connection (e.g., serial port), or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

As shown, server 12 generally includes central processing unit (CPU) 14, memory 16, input/output (I/O) interface 18, bus 20, external I/O devices/resources 22, and a storage unit 24. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Storage unit 24 may comprise any type of data storage for providing more static storage of data used in the present invention. As such, storage unit 24 may include one or more storage devices, such as a magnetic disk drive or an optical disk drive. Moreover, similar to CPU 14, memory 16 and/or storage unit 24 may reside at a single physical location, comprising one or more types of data storage, or be distributed across a plurality of physical systems in various forms. Further, memory 16 and/or storage unit 24 can include data distributed across, for example, a LAN, WAN or a storage area network (SAN) (not shown).

I/O interface 18 may comprise any system for exchanging information to/from one or more I/O devices 22. I/O devices 22 may comprise any known type of external device, including speakers, a CRT, LED screen, handheld device, keyboard, mouse, voice recognition system, speech output system, printer, monitor/display, facsimile, pager, etc. Bus 20 provides a communication link between each of the components in server 12 and likewise may comprise any known type of transmission link, including electrical, optical, wireless, etc. In addition, although not shown, additional components, such as cache memory, communication systems, system software, etc., may be incorporated into server 12.

Further, it is understood that device 26 can comprise any type of computing device capable of communicating with one or more other computing devices (e.g., server 12). For example, device 26 can comprise a server, a desktop computer, a laptop, a handheld device, a mobile phone, a pager, a personal data assistant, etc. To this extent, device 26 typically includes the same elements as shown in server 12 (e.g., CPU, memory, I/O interface, etc.). These have not been separately shown and discussed for brevity. It is understood, however, that if device 26 is a handheld device or the like, a display could be contained within device 26, and not as an external I/O device 22 as shown for server 12.

A user 25 interacts with system 10 by interacting with device 26. For example, user 25 may be requested to provide a user name and/or password to access server 12. User 25 would provide this information to system 10 using device 26. Further, an administrator 27 may also interact with system 10. Administrator 27 may communicate directly with server 12 (e.g., using one or more I/O devices 22) or use a device similar to device 26. Administrator 27 typically monitors and/or manages the operation of system 10. For example, administrator 27 could enter user data into system 10 for a new user 25.

Shown in memory 16 is a management system 28 that includes a generation system 30, a data input system 32, and an entry update system 34. Also shown in memory 16 are a communication system 36, a comparison system 38, and a verification system 40. Operation of the various systems will be described below. While various systems are shown implemented as part of management system 28, it is understood that some or all of the systems can be implemented independently, combined, and/or stored in memory for one or more separate servers 12 that communicate over a network.

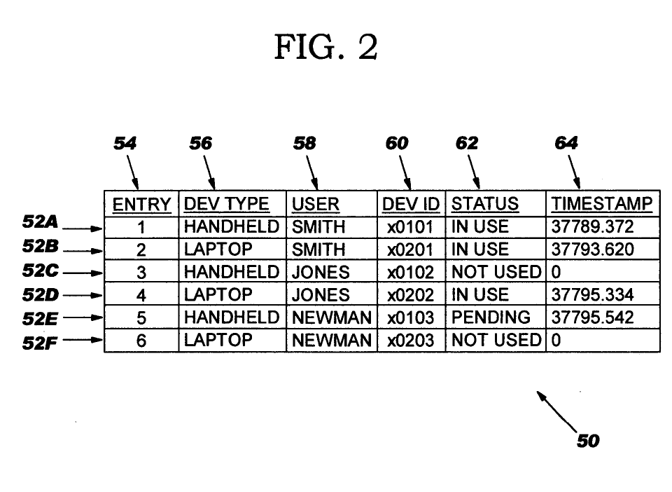

Management system 28 manages a set of device entries on server 12. FIG. 2 shows an illustrative set (e.g., zero or more) of device entries 50. Set of device entries 50 includes device entries 52A-F. Set of device entries 50 can be stored in, for example, storage unit 24 (FIG. 1). To this extent, entry identifier 54 can be included to provide a unique key for each device entry 52A-F. As shown, each device entry 52A-F includes a device identifier 60 and correlation data such as device type 56 and user 58. Generation system 30 (FIG. 1) generates a unique device identifier 60 for each device entry 52A-F. Generation system 30 can automatically generate the unique device identifiers 60, or the unique device identifiers 60 can be selected by, for example, administrator 27 (FIG. 1). In the latter case, generation system 30 can perform a check to ensure that a selected device identifier 60 is unique. In a typical embodiment, device identifiers 60 are generated when each device entry 52A-F is created. In this case, device identifiers 60 could themselves be a unique key, and entry identifier 54 would not be required. However, including both device identifier 60 and entry identifier 54 provides additional flexibility. For example, when a device entry 52A-F is created, device identifier 60 could have a value indicating that it has not been generated (e.g., zero). In this case, device identifier 60 would not have a unique value generated until it is requested.

Correlation data is associated with each device entry 52A-F and could include device data and user data. As indicated above, for device entries 52A-F, the correlation data comprises a device type 56 and a user 58. It is understood that this is only illustrative of possible correlation data. For example, device data could include any combination of a device type, a serial number, a telephone number, an internet protocol address, etc. Similarly, user data could include any combination of a user name, a password, a personal identification number, a passkey, etc. In one embodiment, administrator 27 (FIG. 1) can use data input system 32 (FIG. 1) to enter correlation data. Data input system 32 can then provide the correlation information to entry update system 34 (FIG. 1), which creates device entries 52A-F. For example, administrator 27 may enter user data for a new user named “Smith.” Administrator 27 can then further select/input various device types 56 that Smith can use to access server 12 (e.g., handheld and laptop). Once this information is input, a device entry 52A-B for each device type for Smith can be created. Alternatively, entry update system 34 could automatically create an entry for Smith for all the possible device types. In any event, entries 52C-D are also shown for a user named “Jones,” and entries 52E-F are shown for a user named “Newman.”

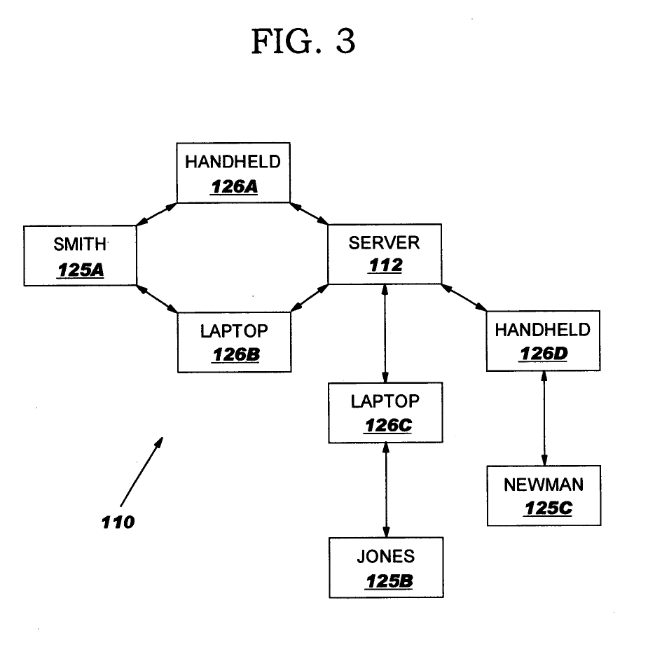

FIG. 3 shows an illustrative embodiment of a system 110 that could correspond to set of device entries 50 (FIG. 2). In order to efficiently communicate with server 112, each device 126A-D is assigned a unique device identifier that is then used when messages are sent between server 112 and a particular device 126A-D. In one embodiment, each device 126A-D is assigned a unique identifier by management system 28 (FIG. 1). For example, Smith 125A may desire to use handheld device 126A to communicate with server 112. Initially, handheld device 126A may require Smith 125A to provide user data (e.g., user name and password) in order to use handheld device 126A. Smith 125A may then request access to server 112. When handheld device 126A does not have a device identifier, it would first send a request for a device identifier to server 112.

Communication system 36 (FIG. 1) would receive the request from handheld device 126A. The request can include correlation data for handheld device 126A that is used to identify the device. In one embodiment, the correlation data comprises a device type for the device (e.g., Handheld), and the user name for the user (e.g., Smith). The device type (or other device data) can be input by the user, automatically detected by the device, or a combination thereof. Communication system 36 can forward the correlation data to verification system 40 (FIG. 1) to verify the correlation data received from handheld device 126A. For example, verification system 40 can confirm a user name and password that are included in the correlation data, or confirm that the user has sufficient privilege to communicate with server 112 using the particular device type.

Once verified, verification system 40 can forward the correlation data to comparison system 38 (FIG. 1). Comparison system 38 obtains a device entry 52A-F (FIG. 2) from set of device entries 50 (FIG. 2) based on the correlation data for handheld device 126A. For example, comparison system 38 can compare the received correlation data to the correlation data in device entries 52A-F to determine if a device entry 52A-F matches the received correlation data. If no matching device entry 52A-F is found, comparison system 38 can generate an error message that is sent to handheld device 126A by communication system 36. Alternatively, comparison system 38 can forward the correlation data to entry update system 34 (FIG. 1), which generates a device entry based on the received correlation data. Entry update system 34 can have generation system 30 (FIG. 1) generate a unique device identifier for the generated device entry. Comparison system can then generate a response for handheld device 126A with the device identifier for the device entry that is communicated to handheld device 126A by communication system 36.

To help ensure that the device identifier is properly received and is being used by a device 126A-D, each device entry 52A-E (FIG. 2) can further include a status 62. In one embodiment, status 62 indicates whether device identifier 60 for the device entry 52A-F is being used, is not being used, or is pending. When device entries 52A-F are created before a request for a device identifier is received, status 62 would be set by entry update system 34 to indicate that the device identifier is unused. Subsequently, comparison system 38 can obtain a device entry in which status 62 indicates that the device identifier is unused. Once assigned to a device 126A-D, status 62 would be set to indicate that the device identifier is in use.

Still further, each device entry 52A-F can also include a timestamp 64. Timestamp 64 can be used to implement a timeout period for receiving messages from devices 126A-D (FIG. 3). For example, handheld device 126D may lose power and/or the communication link with server 112 while still in the process of receiving the device identifier. As a result, status 62 would always indicate that the device identifier is pending. To prevent this, entry update system 34 (FIG. 1) can periodically review all device entries 52A-F having a status 62 of pending, and set the status to unused for device entries 52A-F having a timestamp 64 that is beyond a time out period. This enables these device entries 52A-F to be reused after a certain period of time (e.g., two minutes). Alternatively, entry update system 34 can only modify the status when a new device identifier is requested, and no unused device identifiers are available. When timestamp 64 is included in device entries 52A-F, timestamp 64 can also be included as correlation data to further ensure that the correct device is identified.

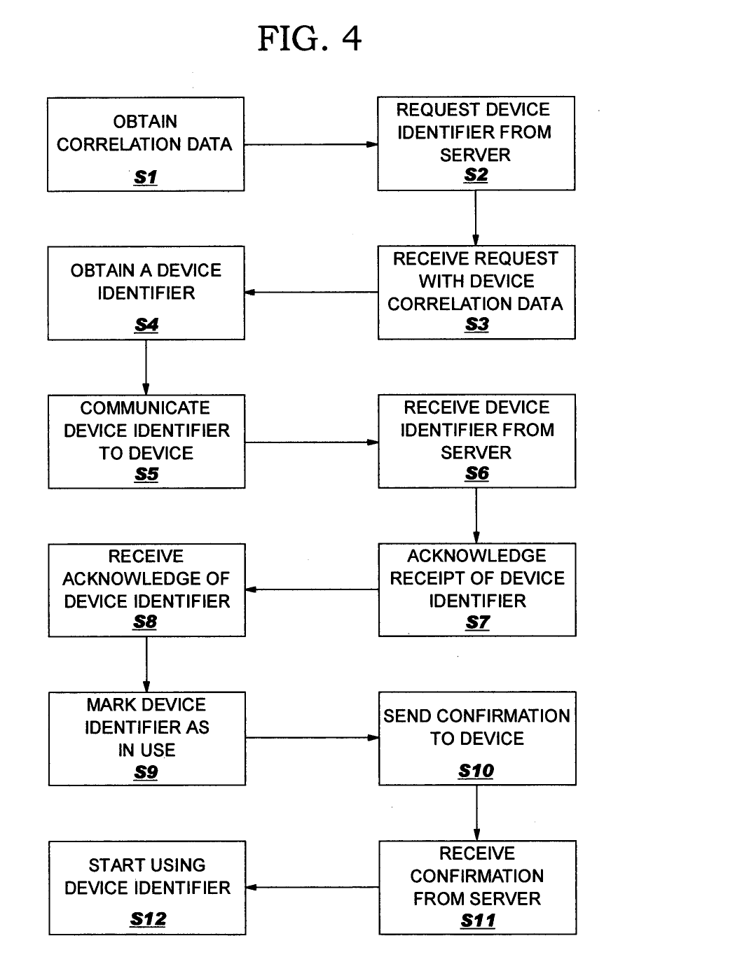

In one embodiment, several messages are used to ensure that device 126A-D is assigned the device identifier. FIG. 4 shows illustrative steps performed by the server, in conjunction with illustrative steps performed by the device. For example, “Newman” 125C (FIG. 3) can request communications with server 112 for the first time using handheld device 126D (FIG. 3). Once handheld device 126D recognizes that it does not have a device identifier, it obtains correlation data in step S1, and sends a request for a device identifier to server 112 in step S2. In step S3, communication system 36 (FIG. 1) receives the request. In step S4, comparison system 38 (FIG. 1) would obtain device entry 52F (FIG. 2) by matching the correlation data received in the request to the correlation data in the device entries. The status 62 of device entry 52F is set to “pending” to indicate that handheld device 126D has requested the device identifier 60 for device entry 52F, but that the request has not yet been fulfilled. In step S5, the device identifier 60 for device entry 52F is communicated to handheld device 126D.

In step S6, handheld device 126D receives the device identifier. In step S7, handheld device 126D can communicate an acknowledgment of the device identifier to server 112. The acknowledgment can include the correlation data along with the received device identifier. In step S8, communication system 36 receives the acknowledgment. Communication system 36 can forward the device identifier and correlation data in the acknowledgment to comparison system 38, which compares the received information to the information in device entry 52F. In step S9, the status 60 for device entry 52F can be set to indicate that the device identifier is in use when the received information matches the information in device entry 52F. In step S10, a confirmation can be sent to handheld device 126D. Similar to the acknowledgment, the confirmation can include the correlation data and the device identifier. In step S11, handheld device 126D receives the confirmation, and in step S12, handheld device 126D permanently stores the device identifier and uses it when subsequently communicating with server 112.

Numerous benefits are obtained by the present invention as will be recognized by one skilled in the art. For example, a user is not required to enter an arbitrary, often long device identifier. Further, the generated device identifiers will be unique since they are all generated at the server. Still further, when device entries are generated prior to receiving a request, a device can be managed at the server prior to making a connection with the server. For example, administrator 27 (FIG. 1) could specify that a message be sent to all devices of a particular device type. Each device entry having the particular device type would be flagged to send the message when the corresponding device next connects with the server. For a device that has not connected yet, the message would be sent the first time it connects with the server.

It is understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various embodiments of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of managing device identifiers, the method comprising:
providing a set of device entries at a server;
generating a unique device identifier for each of the set of device entries; and
associating correlation data with each of the set of device entries, wherein the correlation data includes a device type and user data.

2. The method of claim 1, further comprising obtaining one of the set of device entries based on correlation data for a particular device.

3. The method of claim 2, further comprising:
receiving a request from the particular device for an assigned device identifier, wherein the request includes correlation data for the particular device; and
communicating the device identifier for the one of the set of device entries to the particular device.

4. The method of claim 3, wherein each of the set of device entries further includes a status.

5. The method of claim 4, wherein the status for the obtained one of the set of device entries indicates that the device identifier is unused.

6. The method of claim 4, further comprising setting the status to indicate that the device identifier for the device entry is pending after communicating the device identifier.

7. The method of claim 4, further comprising:
receiving an acknowledgment from the particular device for the communicated device identifier; and
setting the status to indicate that the device identifier for the device entry is in use after receiving the acknowledgment.

8. The method of claim 3, further comprising generating a new device entry based on the received correlation data for the particular device.

9. The method of claim 1, wherein the user data includes at least one of: a user name, a password, a personal identification number, and a passkey.

10. A method of assigning a device identifier, the method comprising:
providing a set of device entries at a server, wherein each device entry includes a device identifier and correlation data;
receiving a request from a device, wherein the request includes correlation data for the device;
identifying one of the set of device entries by comparing the correlation data in the request to the correlation data in the set of device entries; and
communicating the device identifier from the one of the set of device entries to the device.

11. The method of claim 10, further comprising receiving an acknowledgment from the device for the communicated identifier.

12. The method of claim 11, wherein the device entry further includes a status, the method further comprising setting the status to indicate that the device entry is in use after receiving the acknowledgment.

13. The method of claim 10, further comprising:
obtaining user data for a user; and
generating at least one of the set of device entries using the user data for the user before the request is received.

14. A system for managing device identifiers, the system comprising:
a management system for managing a set of device entries at a server, wherein the management system includes:
a generation system for generating a unique device identifier for each of the set of device entries; and
an entry update system for associating correlation data with each of the set of device entries, wherein the correlation data includes a device type and user data.

15. The system of claim 14, wherein the management system further includes a data input system for obtaining correlation data for a user and generating at least one of the set of device entries using the correlation data for the user.

16. The system of claim 14, further comprising a communication system for communicating with a device.

17. The system of claim 14, further comprising a comparison system for obtaining one of the set of device entries based on correlation data for a particular device.

18. The system of claim 14, further including a verification system for verifying correlation data received from a particular device.

19. A program product stored on a recordable medium for managing device identifiers, which when executed comprises:
program code for automatically generating a unique device identifier for each of a set of device entries; and
program code for associating correlation data with each of the set of device entries, wherein the correlation data includes a device type and user data.

20. The program product of claim 19, further comprising program code for communicating the device identifier of one of the set of device entries to a particular device.

21. The program product of claim 19, further comprising:
program code for receiving a request from the particular device, wherein the request includes correlation data for the particular device;
program code for verifying the correlation data for the particular device; and
program code for identifying one of the set of device entries by comparing the correlation data in the request to the correlation data in the set of device entries.

22. The program product of claim 19, further comprising:
program code for obtaining user data for a user; and
program code for generating at least one of the set of device entries using the user data for the user.
